(19) United States
(12) Patent Application Publication
(10) Pub. No.: US 2005/0274728 A1
(43) Pub. Date: Dec. 15, 2005

(54) Tablet automatic packaging machine

(75) Inventor: Jun-ho Kim, Dalseo-Gu (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: JVM CO., LTD, Dalseo-Gu (KR)

(21) Appl. No.: 11/144,707

(22) Filed: Jun. 6, 2005

(30) Foreign Application Priority Data
Jun. 10, 2004 (KR) 10-2004-0042735

(51) Int. Cl. G07F 11/00

(52) U.S. Cl. 221/7

(57) ABSTRACT

A tablet automatic packaging machine is disclosed. The machine includes an identification means and a readout means. The identification means for storing information of tablets contained in tablet cassettes is installed in the rear part of the tablet cassettes. The readout means for reading out the tablet information from the identification means is installed on wall of a main body, corresponding to the identification means. Therefore, the machine can prevent tablet dusts generated when the tablets are discharged from the tablet cassettes from accumulating on the identification means and the readout means.

### BACKGROUND OF THE INVENTION

1. Field of the Invention

The present invention relates to a tablet automatic packaging machine, and more particularly to a tablet automatic packaging machine, which includes an identification means for storing information of tablets contained in tablet cassettes, in which the identification means is installed in the rear part of the tablet cassettes, and a readout means for reading out the tablet information from the identification means, in which the readout means is installed on wall of a main body, corresponding to the identification means, such that it can prevent tablet dusts generated when the tablets are discharged from the tablet cassettes from accumulating on the identification means and the readout means.

2. Description of the Related Art

A prior art tablet automatic packaging machine, as shown in FIG. 6, is operated such that an identification means 202 installed at the lower side of the tablet cassette 200 is read out by a readout means 302 formed on a tablet feeder 300, and positions of the tablet cassettes 200 which are installed thereto by an operator and tablet information are stored in a control unit.

When an operator inputs a prescription, the control unit confirms a position of a corresponding tablet cassette installed thereto and drives a motor in a tablet feeder to which the corresponding tablet cassette in which corresponding tablets are contained is installed thereto. Then, a rotor in the tablet cassette is rotated as the motor geared with the rotor is operated, such that tablets are discharged to the discharge hole based on dosage units. When the tablets are discharged to the discharge hole as the rotor is rotated, tablet dust is generated and accumulates on the identification means installed at the lower part of the tablet cassette and the readout means formed in correspondence to the identification means on the upper surface of the tablet feeder. Therefore, the sensing function of the identification means and the readout means requiring relatively high precision is deteriorated.

### SUMMARY OF THE INVENTION

Therefore, the present invention has been made in view of the above problems, and it is an object of the present invention to provide a tablet automatic packaging machine which includes an identification means of tablet cassettes installed at the rear part of the tablet cassettes and a readout means of tablet feeders which is formed on the wall of a main body, corresponding to the identification means, such that tablet dust generated at the lower side of the tablet cassettes when rotors in the tablet cassettes are rotated cannot accumulate on the identification means and the readout means, thereby maintaining sensing functions of the identification means and the readout mean at a predetermined state.

In accordance with an aspect of the present invention, the above and other objects can be accomplished by the provision of a tablet automatic packing machine comprising: a plurality of tablet cassettes in which tablets are contained; a plurality of tablet feeders on which the plurality of tablet cassettes are mounted, respectively, such that the plurality of tablet cassettes can provide tablets, in which the plurality of tablet feeders are installed on inner walls of a main body; an identification means for storing tablet information, in which the identification means is installed a rear surface of each tablet cassette; a readout means for reading out tablet information, in which the readout means installed on the inner wall of the main body is correspondingly connected to the identification means; and a control unit for storing the tablet information read out from the readout means and position information of each tablet feeder, confirming a tablet feeder on which the tablet cassette containing corresponding tablets is installed, and controlling the tablet feeder to discharge the corresponding tablets based on dosage units.

Preferably, the control unit compares information for kinds of tablets, previously inputted thereto, with that of the tablets respectively inputted through the readout means, and confirms empty tablet cassette. Also, a display displays information of the empty tablet cassette thereon.

Preferably, the identification means includes an installing groove attached to the rear part of the tablet cassette, a memory chip inserted to the inside of the installing groove, and a connection terminal formed in the memory chip to be outwardly protruded from the installing groove.

Preferably, the readout means includes a slot to which the connection terminal of the memory chip is inserted, in which the slot is installed on the wall of the main body, and a reader electrically connected to the control unit, in which the reader is aligned at the rear part of the slot.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view illustrating a table automatic packaging machine according to the present invention;

FIG. 2 is a primary exploded perspective view of a tablet automatic packaging machine according to the present invention;

FIG. 3 is a perspective view illustrating a state wherein the elements in FIG. 2 are assembled;

FIG. 4 is a cross-sectional view of FIG. 3;

FIG. 5 is a block diagram illustrating operation states of the tablet automatic packaging machine according to the present invention; and

FIG. 6 is a cross-sectional view illustrating a prior art tablet automatic packaging machine.

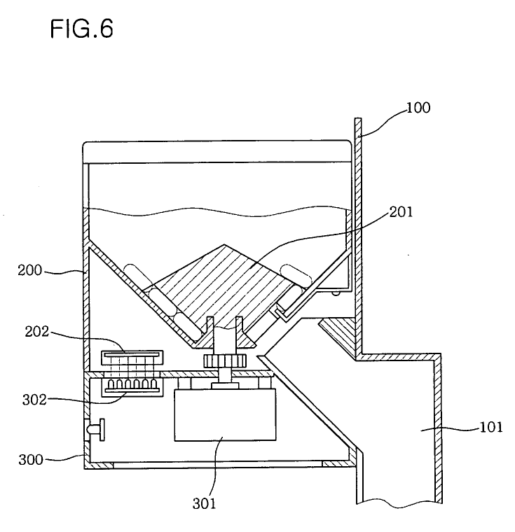

### DESCRIPTION OF THE PREFERRED EMBODIMENTS

With reference to the attached drawings, the preferred embodiment of the present invention is described in detail below.

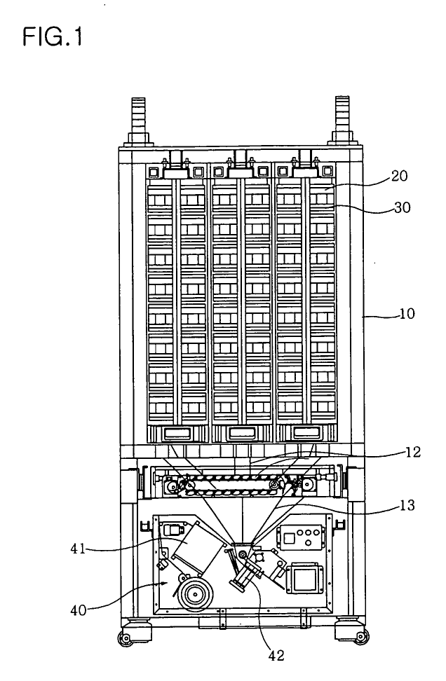

FIG. 1 is a front view illustrating a table automatic packaging machine according to the present invention.

As shown in FIG. 1, the tablet automatic packaging machine is configured such that a plurality of tablet feeders 30 are installed on the wall of a main body 10, and a plurality of tablet cassettes 20 are correspondingly and slidably mounted installed on the plurality of tablet feeders.

Tablets contained in the tablet cassettes 20 are discharged to a collection chute 12 by the tablet feeder 30, in which the collection chute 12 is installed inside the main body 10. The discharge tablets are collected in a hopper 13 and packaged by a package means 40, based on dosage units.

Here, the package means 40 includes a printer 41 printing instructions on pouches, and a sealing unit 42 for heating and sealing the printed pouches.

Namely, the pouches printed by the printer 41 contain tablets, based on dosage units, which are fallen from the hopper 13, while they are conveyed to the sealing unit 42. After that, the pouches are heat sealed in the sealing unit 42.

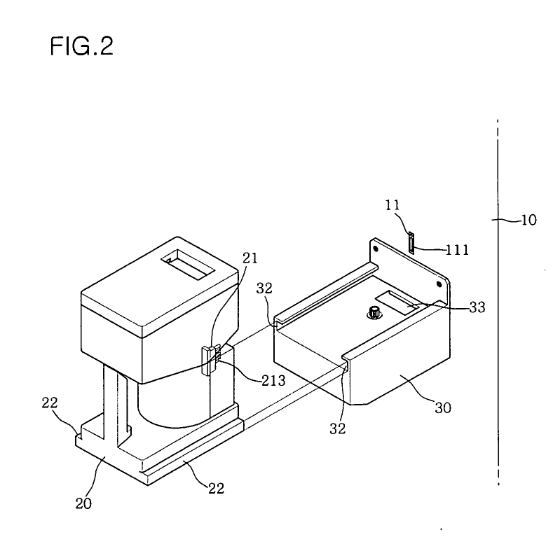

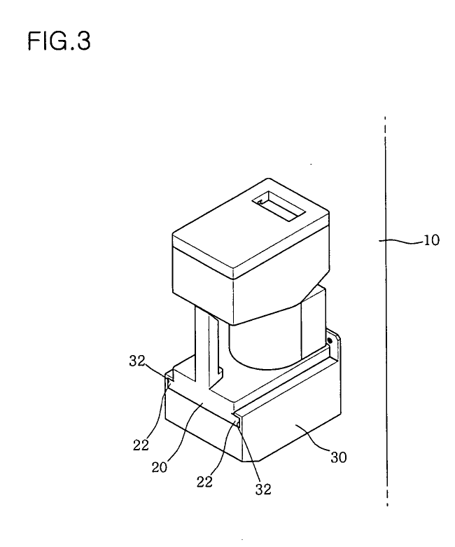

FIG. 2 is a primary exploded perspective view of a tablet automatic packaging machine according to the present invention, and FIG. 3 is a perspective view illustrating a state wherein the elements in FIG. 2 are assembled.

As shown in FIGS. 2 and 3, the tablet cassette 20 is horizontally and slidably coupled to the tablet feeder 30 which is installed on the inner wall of the main body 10.

Namely, the tablet cassette 20 and the tablet feeder 30 are coupled to one another such that guide steps 22 formed at both ends of lower side of the tablet cassette 20 are inserted in to guide grooves 32 of lower side of the tablet feeder 30.

When coupled, a connector 212 of the identification means installed to the rear part of the tablet cassette 20 is inserted to a slot 111 of the readout means 11 installed to the wall of the main body 10. Therefore, tablet information stored in the identification means 21 is read by the readout means 11 and inputted to a control unit together with position information of the tablet feeder 30 installed to the tablet cassette.

When an operator inputs a prescription, the control unit confirms the position of the tablet feeder 30 in which a tablet cassette 20 containing corresponding tablets is installed. After that, the control unit drives a motor within the tablet feeder 30 mounted at the confirmed position, such that a rotor geared with the motor and installed at the tablet cassette 20 can be rotated. Therefore, the corresponding tablets contained in the tablet cassette can be discharged inside the main body 10 through the discharge chute 33.

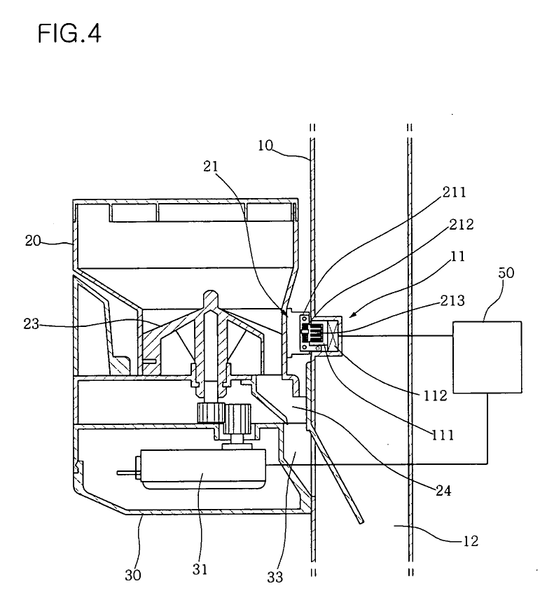

FIG. 4 is a cross-sectional view of FIG. 3.

As shown in FIG. 4, when the tablet cassette 20 is slidably coupled to the tablet feeder 30 installed in the main body 10, the identification means 21, protrudently formed, is inserted and connected to the readout means 11.

Also, since the gears of the motor 31 within the tablet feeder 30 are geared with the gears of the rotor 23 of the tablet cassette 20, the rotor 23 is rotated as the motor 31 drives, such that the tablets contained in the tablet cassette 20 are discharged through the discharge hole 24, pass through the discharge chute 33, and are discharged to the collection chute 12.

The identification means 21 includes an installing groove 211 attached to the rear part of the tablet cassette 20, a memory chip 212 inserted into the installing groove 211, and a connection terminal 213 formed in the memory chip 212 to be outwardly protruded from the installing groove 211.

The identification means 21 is connected to the readout means 11 in a state where information of the tablets contained in the memory chip 212 is stored, and serves to provide the tablet information to the readout means 11.

Also, the readout means 11 includes a slot 111 to which the connection terminal 213 of the memory chip 212 is inserted, in which the slot is installed on the wall of the main body 10, and a reader 112 electrically connected to the control unit 50, in which the reader 112 is aligned at the rear part of the slot 111.

The readout means 11 reads tablet information stored in the memory chip 212 by the reader in a state where the connection terminal 213 of the memory chip 212 is inserted in the slot 111, and serves to input the read tablet information to the control unit 50.

The control unit 50, to which the tablet information from the readout means 11 is input, confirms a position of a tablet cassette 30 corresponding to the read tablet information, and controls the motor to discharge the corresponding tablets.

Accordingly, the tablet automatic packaging machine according to the present invention is configured such that, when an operator couples a tablet cassette 20 to a tablet feeder in a sliding fashion, the identification means 21 and the readout means 11 are mutually coupled to one another, such that information of the tablets contained in the tablet cassette 20 is inputted to the control unit 50, and thus the control unit confirms the position of the tablet cassette 20.

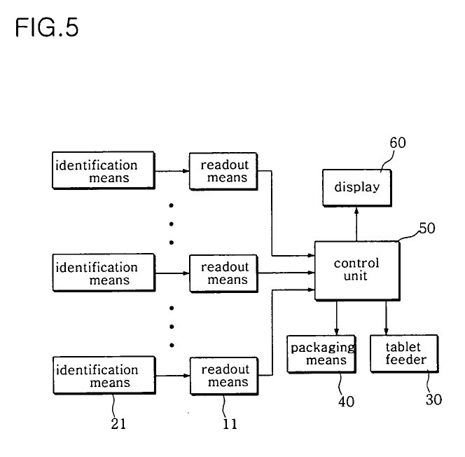

FIG. 5 is a block diagram illustrating operation states of the tablet automatic packaging machine according to the present invention.

As shown in FIG. 5, when a plurality of tablet cassettes, each of which has an identification means 21, are coupled and installed to the tablet feeders 30, the identification means 21 is connected to the readout means 11 such that the control unit 50 can confirm information of the tablets contained in the tablet cassettes.

Here, the control unit 50 compares information for kinds of tablets, previously inputted thereto, with that of the tablets respectively inputted through the readout means 11. For example, if the control unit senses depletion of tablets in a tablet cassette, it displays a message on a display 60 such that the empty tablet cassette may be refilled and reinstalled on the tablet feeder.

The display 60 may be any publicly well-known display device and is electrically connected to the control unit 50.

Also, when corresponding tablets are depleted in a tablet cassette while the tablet automatic packaging machine prepares tablets based on a currently inputted prescription, the control unit confirms the position of a tablet feeder 30 in which the empty tablet cassette is installed and displays the position on the display 60.

The control unit 50 drives a motor within the tablet feeder 30 in which a corresponding tablet cassette is installed according to inputted prescription data to discharge tablets from the tablet cassette based on a dosage unit. After that, the control unit 50 controls a packaging means 40 to seal and package the discharged tablets.

As mentioned above, the tablet automatic packaging machine according to the present invention is configured, such that the identification means is installed in the rear part of the tablet cassettes, and the readout means is installed on a wall of a main body, corresponding to the identification means, thereby preventing tablet dust generated when the rotor is rotated from accumulating on the identification means and the readout means.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A tablet automatic packing machine comprising:
a plurality of tablet cassettes in which tablets are contained;
a plurality of tablet feeders on which the plurality of tablet cassettes are mounted, respectively, such that the plurality of tablet cassettes can provide tablets, in which the plurality of tablet feeders are installed on inner walls of a main body;
an identification means for storing tablet information, in which the identification means is installed a rear surface of each tablet cassette;
a readout means for reading out tablet information, in which the readout means installed on the inner wall of the main body is correspondingly connected to the identification means; and
a control unit for storing the tablet information read out from the readout means and position information of each tablet feeder, confirming a tablet feeder on which the tablet cassette containing corresponding tablets is installed, and controlling the tablet feeder to discharge the corresponding tablets based on dosage units.

2. The machine as set forth in claim 1, wherein the control unit compares information for kinds of tablets, previously inputted thereto, with that of the tablets respectively inputted through the readout means, and confirms empty tablet cassette.

3. The machine as set forth in claim 2, further comprising:
a display electrically connected to the control unit such that information of the empty tablet cassette can be displayed.

4. The machine as set forth in claim 1, wherein the identification means includes an installing groove attached to the rear part of the tablet cassette, a memory chip inserted to the inside of the installing groove, and a connection terminal formed in the memory chip to be outwardly protruded from the installing groove.

5. The machine as set forth in claim 4, wherein the readout means includes a slot to which the connection terminal of the memory chip is inserted, in which the slot is installed on the wall of the main body, and a reader electrically connected to the control unit, in which the reader is aligned at the rear part of the slot.
